(19) United States
(12) Patent Application Publication
(10) Pub. No.: US 2021/0405454 A1
(43) Pub. Date: Dec. 30, 2021

(54) BACKLIGHT MODULE AND LIQUID CRYSTAL MODULE

(71) Applicant: WUHAN CHINA STAR OPTOELECTRONICS TECHNOLOGY CO., LTD., Wuhan (CN)

(72) Inventor: Zheng ZHOU, Wuhan (CN)

(73) Assignee: WUHAN CHINA STAR OPTOELECTRONICS TECHNOLOGY CO., LTD., Wuhan (CN)

(21) Appl. No.: 16/631,461

(22) PCT Filed: Jun. 10, 2019
(86) PCT No.: PCT/CN2019/090508

§ 371 Date: Jan. 16, 2020

(30) Foreign Application Priority Data
May 24, 2019 (CN) 201910441336.4

(51) Int. Cl. G02F 1/13357; G02F 1/1333; F21V 8/00

(52) U.S. Cl. CPC G02F 1/133608; G02F 1/133314; G02B 6/0091; G02F 1/13338; G02B 6/0088; G02F 1/133605

(57) ABSTRACT

A backlight module and a liquid crystal module are provided. The backlight module has a backplate, a light source, a light guiding element, an optical film and a plastic frame. The backplate has a bottom plate and side plates. The bottom plate and the side plates form a receiving chamber. The light source, the light guiding element and the optical film are disposed inside the receiving chamber. The plastic frame is disposed on the backplate. At least one of the side plates is provided with a recess portion at a position corresponding to the optical film, and the recess portion faces toward the optical film. When the optical film is thermally expanded, it extends toward the recess portion.

### FIELD OF INVENTION

The present invention relates to a display field, and more particularly, to a backlight module and a liquid crystal module.

### BACKGROUND OF INVENTION

In current car backlight modules, a cast aluminum part is generally used as a bottom plate, which is limited by size of the module frame, and a gap between the optical film and the sidewall of the cast aluminum part tends to be small. Due to expansion of the optical film under high temperature conditions, when sufficient space between the edge of the film and the sidewall of the cast aluminum part cannot be reserved, the film may wrinkled due to the expansion, thereby causing optical defects.

It is therefore necessary to solve the technical problem that the expansion of an optical film in the current car backlight module is hindered.

### SUMMARY OF INVENTION

The present invention provides a backlight module and a liquid crystal module in order to solve the technical problem that the expansion of an optical film in the current car backlight module is hindered.

To solve above problems, the present invention provides technical solutions as follows:

The present invention provides a backlight module, comprising:

a backplate comprising a bottom plate and side plates, wherein the bottom plate and the side plates form a receiving chamber;

a light source disposed inside the receiving chamber;

a light guiding element disposed inside the receiving chamber, wherein the light source has a light-emitting surface corresponding to a light-input surface of the light guiding element;

an optical film disposed inside the receiving chamber and located on a light-output surface of the light guiding element; and

a plastic frame disposed on the backplate;

wherein at least one of the side plates is provided with a recess portion at a position corresponding to the optical film, and the recess portion faces toward the optical film.

In the backlight module of the present invention, a depth of the recess portion ranges from ¼ to ¾ of a thickness of the side plate.

In the backlight module of the present invention, a width of the recess portion is greater than or equal to a width of the optical film.

In the backlight module of the present invention, a width of the recess portion is less than a width of the optical film, and the optical film has a notch within an area larger than the width of the recess portion at a side of the optical film close to the recess portion.

In the backlight module of the present invention, the light source is disposed between the light guiding plate and at least one of the side plates; or the light source is disposed between the light guiding plate and the bottom plate.

In the backlight module of the present invention, the recess portion has a cross-sectional surface shaped as a right-angled cut or a slot.

In the backlight module of the present invention, the plastic frame has a bottom surface provided with a fixation notch, and the side plate having the recess portion further has a fixation projection, wherein the plastic frame is fixed on the side plate by the fixation notch and the fixation projection.

In the backlight module of the present invention, the fixation notch has a cross-sectional surface shaped as at least one of a rectangle, a trapezoid, and a semicircle.

In the backlight module of the present invention, the fixation projection is formed by a top portion of the side plate having the recess portion, or the fixation projection is formed on a top surface of the side plate having the recess portion.

In the backlight module of the present invention, the fixation projection has a height greater than or equal to a depth of the fixation notch.

In the backlight module of the present invention, the backlight module further comprises a reflective film disposed on the bottom plate.

The present invention further provides a liquid crystal module, comprising:

a backlight module comprising a backplate, a light source, a light guiding plate, an optical film, and a plastic frame, wherein the backplate comprises a bottom plate and side plates, wherein the bottom plate and the side plates form a receiving chamber; the light source, the light guiding plate, and the optical film are disposed inside the receiving chamber, wherein the light source has a light-emitting surface corresponding to a light-input surface of the light guiding element, and the optical film is located on a light-output surface of the light guiding element; the plastic frame is disposed on the backplate; and

a liquid crystal display panel fixed on the plastic frame;

wherein at least one of the side plates is provided with a recess portion at a position corresponding to the optical film, and the recess portion faces toward the optical film.

In the liquid crystal module of the present invention, the plastic frame has a bottom surface provided with a fixation notch, and the side plate having the recess portion further has a fixation projection, wherein the plastic frame is fixed on the side plate by the fixation notch and the fixation projection.

In the liquid crystal module of the present invention, the fixation projection has a height greater than or equal to a depth of the fixation notch.

In the liquid crystal module of the present invention, a depth of the recess portion ranges from ¼ to ¾ of a thickness of the side plate.

In the liquid crystal module of the present invention, the liquid crystal module further comprises a touch panel fixed on the plastic frame.

In the liquid crystal module of the present invention, the backlight module further comprises a reflective film disposed on the bottom plate.

In the liquid crystal module of the present invention, the light source is disposed between the light guiding plate and at least one of the side plates; or the light source is disposed between the light guiding plate and the bottom plate.

In the liquid crystal module of the present invention, the recess portion has a cross-sectional surface shaped as a right-angled cut or a slot.

In the liquid crystal module of the present invention, a width of the recess portion is greater than or equal to a width of the optical film.

The beneficial effects of the present invention are: the present invention provides a backlight module and a liquid crystal module. The backlight module comprises a backplate, a light source, a light guiding element, an optical film and a plastic frame. The backplate has a bottom plate and side plates. The bottom plate and the side plates form a receiving chamber. The light source is disposed inside the receiving chamber. The light guiding element is disposed inside the receiving chamber. The light source has a light-emitting surface corresponding to a light-input surface of the light guiding element. The optical film is disposed inside the receiving chamber and located on a light-output surface of the light guiding element. The plastic frame is disposed on the backplate. It is characterized that at least one of the side plates is provided with a recess portion at a position corresponding to the optical film, and the recess portion faces toward the optical film. By setting a recess portion on the side surface of the backplate corresponding to the position of the optical film, when the optical film is thermally expanded, the recess portion does not block the optical film, and the optical film can extend toward the recess portion, so that wrinkles are not generated, thereby avoiding poor optics.

### BRIEF DESCRIPTION OF DRAWINGS

In order to more clearly illustrate the technical solutions in the embodiment or in the present invention, the following drawings, which are intended to be used in the description of the embodiment or of the present invention, will be briefly described. It is understood that the drawings described below are merely some embodiments of the present invention, and it will be possible to those skilled in the art to obtain other drawings according to these drawings without creative efforts.

FIG. 1 is a schematic view showing a first structure of a backlight module provided by one embodiment of the present invention.

FIG. 2 is a first top view showing a backplate and an optical film in the first structure of the backlight module provided by one embodiment of the present invention.

FIG. 3 is a second top view showing a backplate and an optical film in the first structure of the backlight module provided by one embodiment of the present invention.

FIG. 4 is a schematic view showing a second structure of a backlight module provided by one embodiment of the present invention.

FIG. 5 is a schematic view showing a third structure of a backlight module provided by one embodiment of the present invention.

FIG. 6 is a schematic view showing a fourth structure of a backlight module provided by one embodiment of the present invention.

FIG. 7 shows a main view and a top view of the backplate in the fourth structure of the backlight module provided by one embodiment of the present invention.

FIG. 8 is a schematic view showing a fifth structure of a backlight module provided by one embodiment of the present invention.

FIG. 9 is a schematic view showing a sixth structure of a backlight module provided by one embodiment of the present invention.

FIG. 10 is a schematic view showing a seventh structure of a backlight module provided by one embodiment of the present invention.

FIG. 11 is a schematic view showing an eighth structure of a backlight module provided by one embodiment of the present invention.

FIG. 12 is a schematic view showing a ninth structure of a backlight module provided by one embodiment of the present invention.

FIG. 13 is a schematic view showing a tenth structure of a backlight module provided by one embodiment of the present invention.

FIG. 14 is a schematic view showing a first structure of a liquid crystal module provided by one embodiment of the present invention.

FIG. 15 is a schematic view showing a second structure of a liquid crystal module provided by one embodiment of the present invention.

### DETAILED DESCRIPTION OF PREFERRED EMBODIMENTS

The description of the following embodiments is used for exemplifying the specific embodiments of the present invention by referring to the accompany drawings. Furthermore, directional terms described by the present invention, such as upper, lower, front, back, left, right, inner, outer, side, etc., are only directions by referring to the accompanying drawings, and thus the directional terms are used to describe and understand the present invention, but the present invention is not limited thereto. In the drawings, like reference numerals designate like elements throughout the specification.

The present invention provides a backlight module and a liquid crystal module in order to solve the technical problem that the expansion of an optical film in the current car backlight module is hindered.

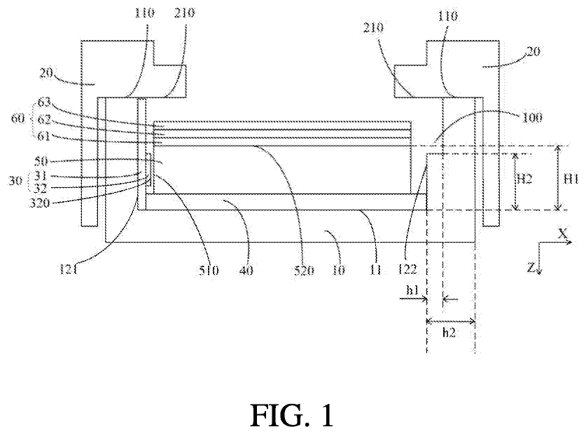

As shown in FIG. 1, which is a schematic view showing a first structure of a backlight module provided by one embodiment of the present invention. The backlight module comprises a backplate 10, a plastic frame 20, a light source 30, a reflective film 40, a light guiding element 50, and an optical film 60.

The backplate 10 generally uses cast aluminum to ensure the strength and better heat dissipation. The backplate 10 comprises a bottom plate and side plates. The bottom plate and the side plates form a receiving chamber.

The light source 30 is disposed inside the receiving chamber, and the light source 30 is disposed between the light guiding element 50 and at least one of the side plates; or the light source 30 is disposed between the light guiding element 50 and the bottom plate. In this embodiment, the backlight module is an edge type backlight module, and the light source 30 is disposed between the light guiding element 50 and at least one of the side plates.

Generally, the light source 30 is disposed between the light guiding element 50 and a side surface. It is also possible that the light source 30 is disposed between the light guiding element 50 and several side surfaces. When the light source 30 is only disposed between the light guiding element 50 and a first side surface 121, as shown in FIG. 1, the light source 30 comprises a light bar 31 and LED lamps 32 fixed on the light bar 31, and the light bar 31 is fixed on the first side surface 121.

The light guiding element 50 is disposed inside the receiving chamber, and the light guiding element 50 has a light-input surface 510 corresponding to a light-emitting surface 320 of the light source 30. Since the backlight module is an edge type backlight module, the light guiding element 50 can be a light guiding plate, the light guiding plate transfers the horizontal incident light from the light source 30 into vertical light and then passing through a light-emitting surface 520 of the light guiding element 50. The light guiding plate is generally formed by an optical resin material, and a thermoplastic resin, polycarbonate, and acrylic are commonly used materials.

A reflective film 40 is provided under the light guiding element 50. The reflective film 40 is disposed on the bottom plate of the backplate 10. The reflective film 40 is generally composed of a polyethylene terephthalate (PET) film coated with a high reflective metallic film thereon, or a PET composite formed by two layers of PET films with one core layer (polymer resins having high reflectance) between the two layers of PET films. The reflective film 40 is mainly used for reflecting the light leakage from the light guiding element 50 so as to increase the use of the light source.

The optical film 60 is disposed inside the receiving chamber, and located on the light-emitting surface 520 of the light guiding element 50. The optical film 60 generally includes a diffuser 61, a prism sheet 62, and a reflective polarization and brightness enhancement film 63 in stacking arrangement. The diffuser 61 is commonly formed by polyethylene terephthalate (PET) or polycarbonate (PC) with a smooth front and a rough back. The diffuser 61 is used for multiple refraction, reflection and scattering the light passing out from the light-emitting surface 520 of the light guiding element 50 so that the backlight can be more even. The prism sheet 62 is a light-gathering device that uses total reflection and refraction law to gather the scattered light and let the light exit within a certain angle, thereby increasing the brightness within an area. The reflective polarization and brightness enhancement film 63 can also increase the brightness of the backlight.

The plastic frame 20 generally uses polycarbonate or polycarbonate mixed with glass fibers. The plastic frame 20 is disposed on the backplate 10. As shown in FIG. 1, the backplate 10 comprises a first top surface 110. The plastic frame 20 comprises a first bottom surface 210. The first bottom surface 210 of the plastic frame 20 is formed on the first top surface 110 of the backplate 10.

In the current car backlight module, a cast aluminum part is generally used as a bottom plate, which is limited by the size of the module frame, and the gap between the optical film and the sidewall of the cast aluminum part is small. Due to the expansion of the optical film under high temperature conditions, when the sufficient space between the edge of the film and the sidewall of the cast aluminum part cannot be reserved, the film may be wrinkled due to the expansion, thereby causing optical defects.

In this application, the backplate 10 has at least one of the side plates provided with a recess portion 100 at a position corresponding to the optical film 60, and the recess portion 100 faces toward the optical film 60. When the optical film 60 is thermally extended toward a horizontal direction X, the recess portion 100 does not block the optical film 60. The optical film 60 can extend toward the recess portion 100 so that wrinkles are not generated, thereby avoiding poor optics.

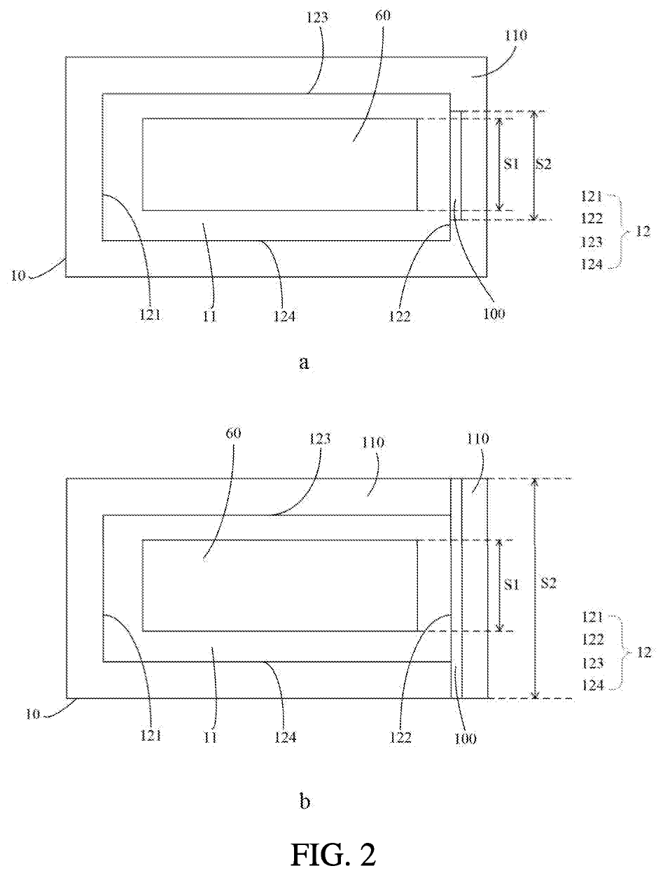

As shown in FIG. 2, which is a first top view showing a backplate and an optical film in the first structure of the backlight module provided by one embodiment of the present invention. The backplate 10 comprises a bottom plate and side plates. The bottom plate and the side plates form a receiving chamber. The receiving chamber comprises a bottom surface 11 and a side surface 12. The bottom surface 11 of the receiving chamber is an upper surface of the bottom plate. The side surface 12 is an inner surface of the side plates. The side plates comprise a first side plate, a second side plate, a third side plate, and a fourth side plate connected with the bottom plate (not shown). The side surface 12 comprises a first side surface 121, a second side surface 122, a third side surface 123, and a fourth side surface 124 connected with the bottom surface 11. It is characterized that the first side surface 121 and the second side surface 122 are opposite to each other, and the third side surface 123 and the fourth side surface 124 are opposite to each other. It is understood by referring to FIG. 2 and FIG. 1, in this embodiment, the first side surface 121, the second side surface 122, the third side surface 123, and the fourth side surface 124 of the backplate 10 all connect with and perpendicular to the first top surface 110.

For example, as shown in FIG. 1, there is only the light source 30 disposed between the light guiding element 50 and the first side plate. In one embodiment, the recess portion 100 is only formed on the second side surface 122. When the optical film 60 is thermally extended toward the second side surface, the recess portion 100 does not block the optical film 60, and the optical film 60 can extend toward the recess portion 100, so that wrinkles are not generated, thereby avoiding poor optics. Specifically, it is also possible to form a recess portion 100 on the third side surface 124 or the fourth side surface 124, the principle is the same as the second side surface 122.

In one embodiment, the recess portion 100 is formed on each of two opposite side surfaces. For example, the recess portion 100 is formed on the third side surface and the fourth side surface. When the optical film 60 is thermally extended toward the third side surface 123 and the fourth side surface 124, the two recess portions 100 do not block the optical film 60. The optical film 60 can extend in two directions toward the two recess portions 100, so that wrinkles are not generated, thereby avoiding poor optics.

In one embodiment, the recess portions 100 are formed on two side surfaces adjacent to each other. For example, the recess portions 100 are formed on the second side surface 122 and the third side surface 123. When the optical film 60 extends to the first side surface 121, since the first side surface 121 has the light source 30 thereon, there is a certain distance between the optical film 60 and the backplate 10 so that the extension does not been blocked. When the optical film 60 extends toward the second side surface 122, the recess portion 100 on the second side surface 122 does not block the optical film 60. The optical film 60 can extend toward the recess portion 100 on the second side surface 122. When the optical film 60 extends toward the third side surface 123, the recess portion 100 on the third side surface 123 does not block the optical film 60, and the optical film 60 can extend toward the recess portion 100 on the third side surface 123. When the optical film 60 extends toward the fourth side surface 124, although the recess portion 100 is not formed on the fourth side surface 124, the optical film 60 can extend toward a reverse direction if the optical film 60 encounters blocking, that is, the optical film 60 extends toward the third side surface 123. The recess portion 100 on the third side surface 123 does not block the optical film 60 and the optical film 60 can extend toward the recess portion 100 on the third side surface 123, so that wrinkles are not generated, thereby avoiding poor optics.

In one embodiment, the second side surface 122, the third side surface 123, and the fourth side surface 124 all have the recess portions 100. When the optical film 60 is thermally extended around, the optical film 60 does not been blocked, so that wrinkles are not generated, thereby avoiding poor optics.

In one embodiment, the first side surface 121, the second side surface 122, the third side surface 123, and the fourth side surface 124 all have the recess portions 100. When the optical film 60 is thermally extended around, the optical film 60 does not been blocked, so that wrinkles are not generated, thereby avoiding poor optics.

The light source 30 can be disposed between the light guiding element 50 and two or three side plates. The recess portion 100 on the side plates without the light source 30 is formed by the same method in the above embodiment. The recess portion 100 can be formed on all of the side plates, it is also possible to form the recess portion 100 on a part of the side plates.

As shown in FIG. 1 and FIG. 2, in this embodiment, the recess portion 100 has a cross-sectional surface shaped as a right-angled cut. That is, when the recess portion 100 is formed, it is also cut by a horizontal direction X and a vertical direction Z. In order to ensure that the optical film 60 is unblocked when it expands, the cutting depth along the horizontal direction X is sufficient to ensure the thickness of the cast aluminum part (minimum thickness 0.8 mm) and sufficient expansion gap at high temperature is reserved for the optical film 60. In one embodiment, the recess portion 100 has a depth ranging from ¼ to ¾ of the thickness of the side plate.

When cutting along the vertical direction Z, the recess portion 100 has a height H2 from the bottom surface 11 less than or equal to a height H1 from the bottom surface 11 of the optical film 60. In this embodiment, the difference between H1 and H2 is 0.1 to 0.2 mm. That is, when the optical film 60 expends and enters the recess portion 100, a direction of 0.1 to 0.2 mm is maintained in the vertical direction Z between the bottom portion of the optical film 60 and the backplate 10, and this ensures that the optical film 60 can smoothly expand into the recess portion 100 without colliding with the backplate 10.

In one embodiment, as shown in FIG. 2, the width S2 of the recess portion 100 is greater than or equal to the width S1 of the optical film 60, and this ensures that the optical film 60 can smoothly expand into the recess portion 100 without colliding with the backplate 10. When the width S2 of the recess portion 100 is greater than or equal to the width S1 of the optical film 60, the recess portion 100 can be formed by several methods.

As shown by “a” in FIG. 2, the recess portion 100 is only formed inside the receiving chamber. That is, the width S2 of the recess portion 100 is less than or equal to a distance between the third side surface 123 and the fourth side surface 124.

As shown by “b” in FIG. 2, the recess portion 100 is only formed inside the receiving chamber and passing through the outside of the side plate of the backplate 10. At this time, the first top surface 110 of the second side plate is separated from the first top surface 110 of the other side plates.

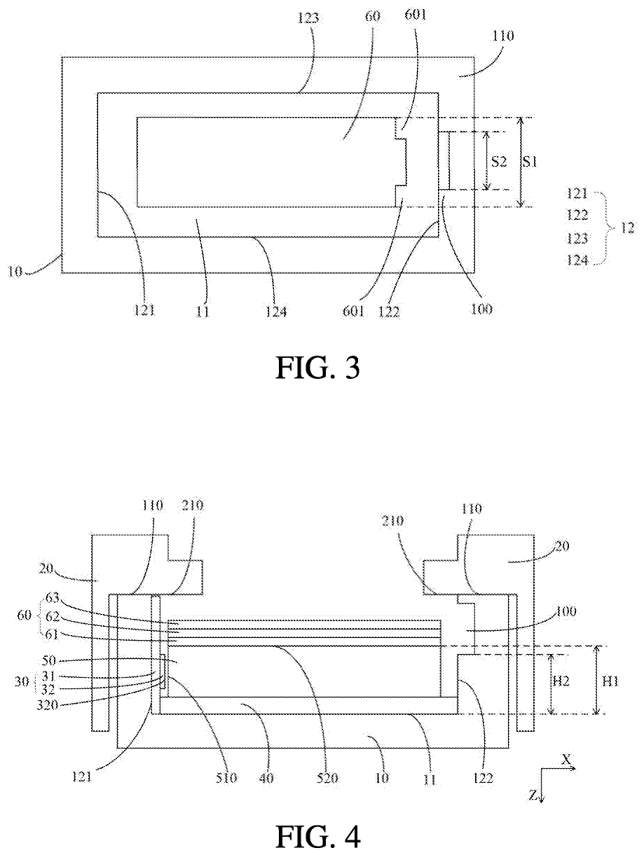

In one embodiment, as shown in FIG. 3, a width S2 of the recess portion 100 is less than a width S1 of the optical film 60. The optical film 60 has a notch 601 within an area larger than the width of the recess portion 100 at a side of the optical film 60 close to the recess portion 100. When the optical film 60 expands into the recess portion 100, since the notch 601 is formed, this ensures that the optical film 60 can smoothly expand into the recess portion 100 without colliding with the backplate 10.

It should be noted that the shape of the recess portion 100 is not limited thereto. The shape of the recess portion 100 can be other shapes. As long as the bottom surface and the side surface of the optical film 60 are both not in contact with the backplate 10 when it expands, the person skilled in the art can design the shape of the recess portion 100 as needed.

As shown in FIG. 4, which is a schematic view showing a second structure of a backlight module provided by one embodiment of the present invention. The backlight module comprises a backplate 10, a plastic frame 20, a light source 30, a reflective film 40, a light guiding element 50, and an optical film 60.

The difference between FIG. 4 and FIG. 1 is that in this embodiment the recess portion 100 has a cross-sectional surface shaped as a slot. The cross-sectional surface of the slot can be a rectangle, a trapezoid, or a semicircle. When the recess portion 100 is a slot, the first top surface 110 of the backplate 10 has a larger area than the right-angled cut of the cross-sectional surface of the recess portion 100 in FIG. 1. Thus, the support for the plastic frame 20 and the backlight space is stronger, and the slot does not block the optical film 60 when the optical film is thermally extended toward a horizontal direction X, and the optical film 60 can extend toward the recess portion 100, so that wrinkles are not generated, thereby avoiding poor optics.

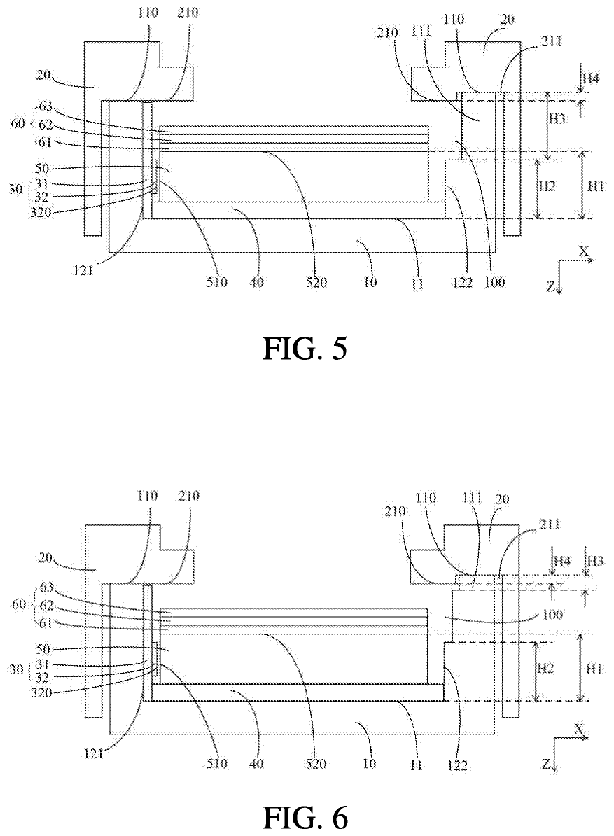

As shown in FIG. 5, which is a schematic view showing a third structure of a backlight module provided by one embodiment of the present invention. The backlight module comprises a backplate 10, a plastic frame 20, a light source 30, a reflective film 40, a light guiding element 50, and an optical film 60.

The first bottom surface 210 of the plastic frame 20 is formed on the first top surface 110 of the backplate 10. The difference between this structure and what FIG. 1 showing is that the first bottom surface 210 of the plastic frame 20 in this embodiment is provided with a fixation notch 211, and the side plate having the recess portion 100 is provided with a fixation projection 111. The plastic frame 20 is fixed on the side plate by the fixation notch 211 and the fixation projection 111.

The cross-sectional surface of the fixation notch 211 can be at least one of a rectangle, a trapezoid, and a semicircle. In this embodiment, the fixation projection 111 is directly formed by a top portion of the side plate having the recess portion 100. That is, when the recess portion 100 is formed, a portion of the first top surface 110 of the backplate 10 is cut down along the vertical direction Z, and the first top surface 110 has an area reduced relative to the original one. The remaining portion of the first top surface 110 of the backplate 10 forms the fixation projection 111 engaged in the fixation notch 211.

Since the fixation projection 111 needs to be engaged in the fixation notch 211, the formation of the recess portion 100 is shown by “b” in FIG. 2 when the fixation projection 111 is directly formed by the recess portion 100. The recess portion 100 is formed inside the receiving chamber and passes through the backplate 10 to the outside of the side plate. At this time, the first top surface 110 of the second side plate is separated from the first top surface 110 of the other side plates. That is, the top portion of the fixation projection 111 is independent of the rest of the backplate 10, and the fixation projection 111 can be embedded in the fixation notch 211.

The shape of the fixation projection 111 depends on the shape of the recess portion 100. In one embodiment, the shape of the fixation projection 111 is the same as that of the fixation notch 211. The cross-sectional surface of them are both at least one of a rectangle, a trapezoid, and a semicircle, or other shapes.

In one embodiment, the shape of the fixation projection 111 is different from that of the fixation notch 211. For example, the shape of the fixation notch 211 is a rectangle, but the shape of the fixation projection 111 is a semicircle. The shapes of the fixation projection 111 and the fixation notch 211 can be designed by requirement.

The height H3 of the fixation projection 111 is greater than or equal to the depth H4 of the fixation notch 211, and this ensures that the fixation projection 111 can fully extended into the fixation notch 211, support the plastic frame 20 and the backlight space in the vertical direction Z, while ensuring that the horizontal section of the recess portion 100 does not interfere with the first bottom surface 210 of the plastic frame 20.

The present invention provides a fixation notch 211 on the first bottom surface 210 of the plastic frame 20 and a fixation projection 111 on the first top surface 110 of the backplate 10 and the fixation projection 111 is embedded in the fixation notch 211. On one aspect, the backplate 10 can support the plastic frame 20 and the backlight space in the vertical direction Z, and on another aspect, the backplate 10 can stuck the plastic frame 20 in the horizontal direction X to avoid the thin side wall of the plastic frame 20 and then causing excessive deformation.

As shown in FIG. 6, which is a schematic view showing a fourth structure of a backlight module provided by one embodiment of the present invention. The backlight module comprises a backplate 10, a plastic frame 20, a light source 30, a reflective film 40, a light guiding element 50, and an optical film 60.

The difference between this embodiment and the structure in FIG. 5 is that the fixation projection 111 is formed on a top surface of the side plate having the recess portion 100 in this embodiment. That is, the fixation projection 111 in FIG. 6 is additionally formed on the first top surface 110 of the backplate 10 rather than directly formed by the top portion of the side plate having the recess portion 100.

There are many ways to form the fixation projection 111.

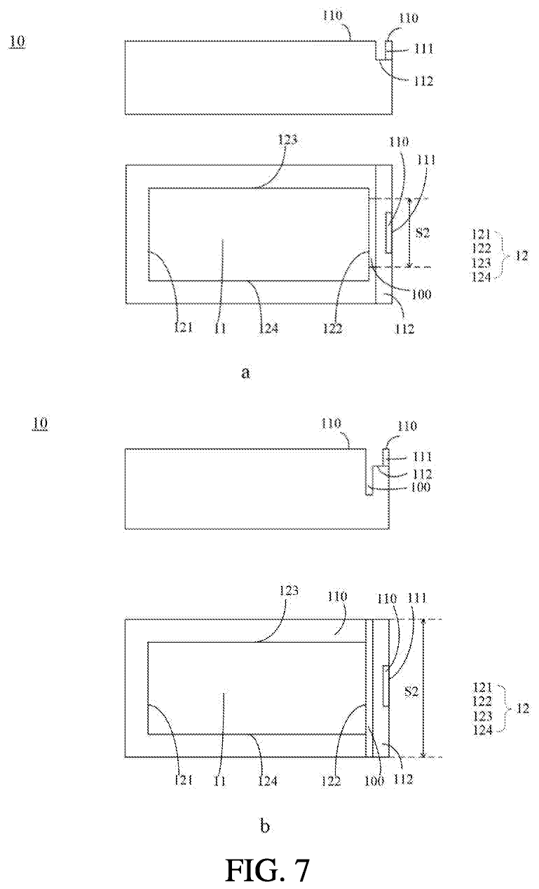

In one embodiment, a portion of the first top surface 110 of the backplate 10 is cut down in the vertical direction Z to form a recess portion 100, and then cutting the first top surface 110 off once again or several times. At last, the remaining portion of the top portion forms the fixation projection 111 and is embedded in the fixation notch 211. The formation result is shown in FIG. 7.

As shown in FIG. 7, which shows a main view and a top view of the backplate in the fourth structure of the backlight module provided by one embodiment of the present invention. The cross-sectional surface of the recess portion 100 is a right-angled cut. There are many ways to form the recess portion 100.

As shown by “a” in FIG. 7, the recess portion 100 is only formed inside the receiving chamber. That is, the width S2 of the recess portion 100 is less than or equal to a distance between the third side surface 123 and the fourth side surface 124. The fixation projection 111 is formed on the first top surface 110. When the recess portion 100 is formed, a portion of the first top surface 110 of the second backplate is cut off. When forming the fixation projection 111, the remaining first top surface 100 is cut once again or several times. The cut off portion is 112, and the remaining portion forms the fixation projection 111.

As shown by “b” in FIG. 7, the recess portion 100 is only formed inside the receiving chamber and passes to the outside of the side plate of the backplate 10. At this time, the first top surface 110 of the second side plate is separated from the first top surface 110 of the other side plates. The fixation projection 111 is formed on the first top surface 110 of the second side plate. When the recess portion 100 is formed, a portion of the first top surface 110 of the second backplate is cut off, so that the first top surface 110 of the second side plate is separated from the first top surface 110 of the other side plates. When forming the fixation projection 111, the remaining first top surface 100 of the second side plate is cut once again or several times. The cut off portion is 112, and the remaining portion forms the fixation projection 111.

The number of the fixation projection 111 can be one or multiple. The number of the fixation notch 211 on the plastic frame 20 is equal to the number of the fixation projection 111

In one embodiment, a portion of the first top surface 110 of the backplate 10 is cut down in the vertical direction Z to form a recess portion 100, and then a material is added to the first top surface 110 to form the fixation projection 111. The added material can be same as or different from the material of the backplate 10. Then, the fixation projection 111 is embedded in the fixation notch 211.

In this embodiment, the fixation projection 111 has smaller size, and thus the fixation notch 211 formed on the first bottom surface 210 of the plastic frame 20 can be smaller.

The shapes of the fixation projection 111 and the fixation notch 211 can be same or different. The height H3 of the fixation projection 111 is greater than or equal to the depth H4 of the fixation notch 211, and this ensures that the fixation projection 111 can fully extended into the fixation notch 211, support the plastic frame 20 and the backlight space in the vertical direction Z, while ensuring that the horizontal section of the recess portion 100 does not interfere with the first bottom surface 210 of the plastic frame 20.

The present invention provides a fixation notch 211 on the first bottom surface 210 of the plastic frame 20 and a fixation projection 111 on the first top surface 110 of the backplate 10 and the fixation projection 111 is embedded in the fixation notch 211. On one aspect, the backplate 10 can support the plastic frame 20 and the backlight space in the vertical direction Z, and on another aspect, the backplate 10 can stuck the plastic frame 20 in the horizontal direction X to avoid the thin side wall of the plastic frame 20 and then causing excessive deformation.

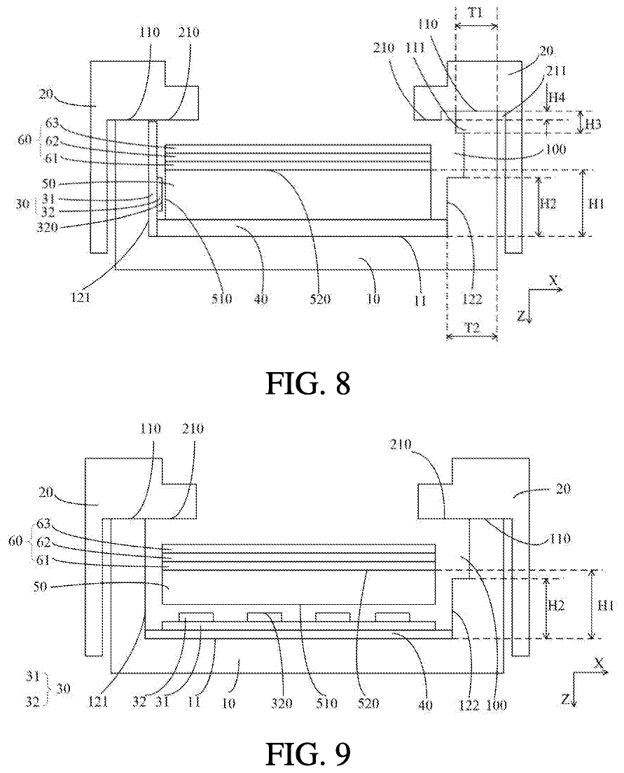

As shown in FIG. 8 which is a schematic view showing a fifth structure of a backlight module provided by one embodiment of the present invention. The backlight module comprises a backplate 10, a plastic frame 20, a light source 30, a reflective film 40, a light guiding element 50, and an optical film 60.

The difference between this embodiment and the structure shown in FIG. 5 is that the recess portion 100 has a cross-sectional surface shaped as a slot in this embodiment. The shape of the slot can be a rectangle, a trapezoid, or a semicircle. The projection 111 is directly formed by the recess portion 100. That is, the remaining portion of the upper portion of the slot forms the projection 111 and is embedded in the first slot 211 after the slot is formed.

When the recess portion 100 is a slot, the first top surface 110 of the backplate 10 has a larger area than the right-angled cut of the cross-sectional surface of the recess portion 100. Thus, the support for the plastic frame 20 and the backlight space is stronger, and the slot does not block the optical film 60 when the optical film 60 is thermally extended toward a horizontal direction X, and the optical film 60 can extend toward the recess portion 100, so that wrinkles are not generated, thereby avoiding poor optics

In this embodiment, the fixation projection 111 is directly formed by the top portion of the side plate having the recess portion 100. It is noted that because the fixation projection 111 needs to be embedded in the fixation notch 211 and the recess portion 100 has a cross-section shaped as a slot, a thickness T1 of the side plate on the upper portion of the slot have to be less than a thickness T2 of the side plate on the lower portion of the slot when forming the slot as shown in FIG. 8. Meanwhile, the recess portion 100 is formed inside the receiving chamber and passes outside of the side plate of the backplate 10, and the first top surface 110 of the second side plate is separated from the first top surface 110 of the other side plate. That is, the top portion of the fixation projection 111 is independent from the other portion of the backplate 10. The fixation projection 111 can be embedded in the fixation notch 211.

The present invention provides a fixation notch 211 on the first bottom surface 210 of the plastic frame 20 and a fixation projection 111 on the first top surface 110 of the backplate 10 and the fixation projection 111 is embedded in the fixation notch 211. On one aspect, the backplate 10 can support the plastic frame 20 and the backlight space in the vertical direction Z, and on another aspect, the backplate 10 can stuck the plastic frame 20 in the horizontal direction X to avoid the thin side wall of the plastic frame 20 and then causing excessive deformation.

As shown in FIG. 9, which is a schematic view showing a sixth structure of a backlight module provided by one embodiment of the present invention. The backlight module comprises a backplate 10, a plastic frame 20, a light source 30, a reflective film 40, a light guiding element 50, and an optical film 60.

In this embodiment, the backlight module is a direct type backlight module in this embodiment. The light source 30 is disposed between the light guiding element 50 and the bottom plate of the backplate 10. The reflective film 40 is disposed between the light source 30 and the backplate 10. The light source 30 emits light bottom up. The light-input surface 510 of the light guiding element 50 corresponds to the light-emitting surface 320 of the light source 30.

In this embodiment, the light guiding element 50 is a diffuser. The diffuser fully scatters the incident light from the light source 30 and has a good shadowing effect on the light shadow, making the light source softer and more uniform.

Since the side surface of the backplate 10 comprises a first side surface 121, a second side surface 122, a third side surface 123 and a fourth side surface 124, and the light source 30 is disposed between the light guiding element 50 and the bottom plate of the backplate, at least one of the first side surface 121, the second side surface 122, the third side surface 123, and the fourth side surface 124 has the recess portion 100 formed thereon.

In one embodiment, the recess portion is formed on the second side surface 122 only. When the optical film 60 is thermally extended, the recess portion 100 does not block the optical film 60, and the optical film 60 can extend toward the recess portion 100, so that wrinkles are not generated, thereby avoiding poor optics. Of course, it is possible to form the recess portion 100 only on the first side surface 121, the third side surface 123, or the fourth side surface 124 by the specific principle same as the second side surface 122.

In one embodiment, the recess portion 100 is formed on each of two opposite side surfaces. For example, the recess portion 100 is formed on the first side surface 121 and the second side surface 122. When the optical film 60 is thermally extended toward the first side surface 121 and the second side surface 122, the two recess portions 100 do not block the optical film 60. The optical film 60 can extend in two directions toward the two recess portions 100, so that wrinkles are not generated, thereby avoiding poor optics. It is also possible to form a recess portion 100 on the third side surface 123 and the fourth side surface 124 by the same principle.

In one embodiment, the recess portion 100 is formed on each of two adjacent side surfaces. For example, the recess portion 100 is formed on the first side surface 121 and the third side surface 123. When the optical film 60 is thermally extended toward the first side surface 121, since the first side surface 121 has the recess portion 100, the optical film 60 can extend toward the recess portion 100 on the first side surface 121. When the optical film 60 extends toward the third side surface 123, since the third side surface 123 has the recess portion 100, the optical film 60 can extend toward the recess portion 100 on the third side surface 123. Meanwhile, when the optical film 60 extends toward the second side surface 122 and the fourth side surface 124, although the recess portion 100 is not formed on any of the second side surface 122 and the fourth side surface 124, the optical film 60 can extend toward a reverse direction if the optical film 60 encounters blocking. That is, the optical film 60 would extend toward the first side surface 121 and the third side surface 123. The recess portion 100 on each of the first side surface 121 and the third side surface 123 does not block the optical film 60 and the optical film 60 can extend toward the recess portion 100 on each of the first side surface 121 and the third side surface 123, so that wrinkles are not generated, thereby avoiding poor optics.

In one embodiment, the first side surface 121, the second side surface 122, the third side surface 123, and the fourth side surface 124 all have the recess portions 100. When the optical film 60 is thermally extended around, the optical film 60 does not be blocked, so that wrinkles are not generated, thereby avoiding poor optics.

In this embodiment, the recess portion 100 has a cross-sectional surface shaped as a right-angled cut. That is, when the recess portion 100 is formed, it is also cut by a horizontal direction X and a vertical direction Z. In order to ensure that the optical film is unblocked when it expands, the cutting depth along the horizontal direction X is sufficient to ensure the thickness of the cast aluminum part (minimum thickness 0.8 mm) and sufficient expansion gap at high temperature is reserved for the optical film 60. In one embodiment, the recess portion 100 has a depth ranging from ¼ to ¾ of the thickness of the side plate.

When cutting along the vertical direction Z, the recess portion 100 has a height H2 from the bottom surface 11 less than or equal to a height H1 from the bottom surface 11 of the optical film 60. In this embodiment, the difference between H1 and H2 is 0.1 to 0.2 mm. That is, when the optical film 60 expends and enters the recess portion 100, a direction of 0.1 to 0.2 mm is maintained in the vertical direction Z between the bottom portion of the optical film 60 and the backplate 10, and this ensures that the optical film 60 can smoothly expand into the recess portion 100 without colliding with the backplate 10.

The method for forming the recess portion 100 is the same as that of the structure in FIG. 2. It should be noted that the shape of the recess portion 100 is not limited thereto. The shape of the recess portion 100 can be other shapes. As long as the bottom surface and the side surface of the optical film 60 are both not in contact with the backplate 10 when it expands, the person skilled in the art can design the shape of the recess portion 100 as needed.

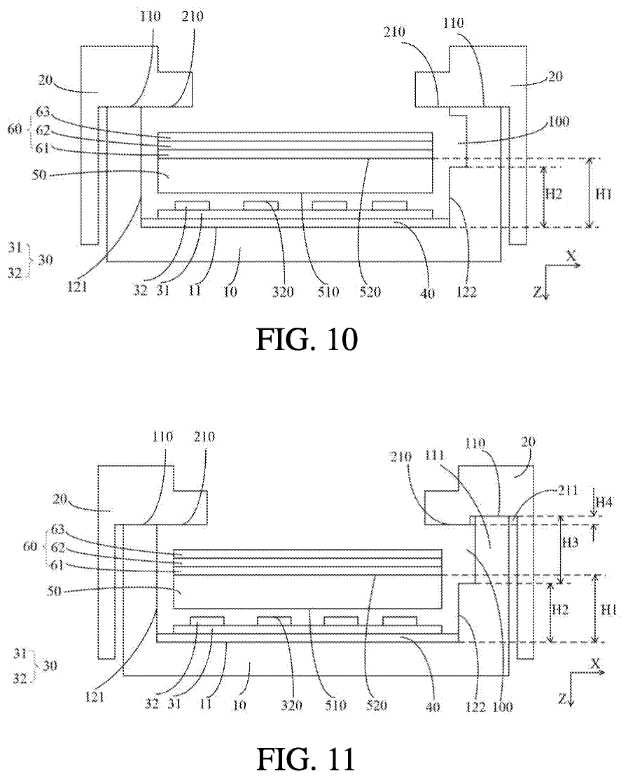

As shown in FIG. 10, which is a schematic view showing a seventh structure of a backlight module provided by one embodiment of the present invention. The backlight module comprises a backplate 10, a plastic frame 20, a light source 30, a reflective film 40, a light guiding element 50, and an optical film 60.

In this embodiment, the backlight module is a direct type backlight module. The difference between this embodiment and FIG. 9 is that in this embodiment the recess portion 100 has a cross-sectional surface shaped as a slot. The cross-sectional surface of the slot can be a rectangle, a trapezoid, or a semicircle. When the recess portion 100 is a slot, the first top surface 110 of the backplate 10 has a larger area than the right-angled cut of the cross-sectional surface of the recess portion 100. Thus, the support for the plastic frame 20 and the backlight space is stronger, and the slot does not block the optical film 60 when the optical film is thermally extended toward a horizontal direction X, and the optical film 60 can extend toward the recess portion 100, so that wrinkles are not generated, thereby avoiding poor optics.

As shown in FIG. 11, which is a schematic view showing an eighth structure of a backlight module provided by one embodiment of the present invention. The backlight module comprises a backplate 10, a plastic frame 20, a light source 30, a reflective film 40, a light guiding element 50, and an optical film 60.

In this embodiment, the backlight module is a direct type backlight module. The first bottom surface 210 of the plastic frame 20 is formed on the first top surface 110 of the backplate 10. The difference between this structure and what FIG. 9 showing is that the first bottom surface 210 of the plastic frame 20 in this embodiment is provided with a fixation notch 211, and the side plate having the recess portion 100 is provided with a fixation projection 111. The plastic frame 20 is fixed on the side plate by the fixation notch 211 and the fixation projection 111.

The cross-sectional surface of the fixation notch 211 can be at least one of a rectangle, a trapezoid, and a semicircle. In this embodiment, the fixation projection 111 is directly formed by a top portion of the side plate having the recess portion 100. That is, when the recess portion 100 is formed, a portion of the first top surface 110 of the backplate 10 is cut down along the vertical direction Z, and the first top surface 110 has an area reduced relative to the original one. The remaining portion of the first top surface 110 of the backplate 10 forms the fixation projection 111 engaged in the fixation notch 211.

Since the fixation projection 111 needs to be engaged in the fixation notch 211, the formation of the recess portion 100 is shown by “b” in FIG. 2 when the fixation projection 111 is directly formed by the recess portion 100. The recess portion 100 is formed inside the receiving chamber and passes through the backplate 10 to the outside of the side plate. At this time, the first top surface 110 of the second side plate is separated from the first top surface 110 of the other side plates. That is, the top portion of the fixation projection 111 is independent of the rest of the backplate 10, and the fixation projection 111 can be embedded in the fixation notch 211.

The shape of the fixation projection 111 depends on the shape of the recess portion 100. In one embodiment, the shape of the fixation projection 111 is the same as that of the fixation notch 211. The cross-sectional surface of them are both at least one of a rectangle, a trapezoid, and a semicircle, or other shapes.

In one embodiment, the shape of the fixation projection 111 is different from that of the fixation notch 211. For example, the shape of the fixation notch 211 is a rectangle, but the shape of the fixation projection 111 is a semicircle. The shapes of the fixation projection 111 and the fixation notch 211 can be designed by requirement.

The height H3 of the fixation projection 111 is greater than or equal to the depth H4 of the fixation notch 211, and this ensures that the fixation projection 111 can fully extended into the fixation notch 211, support the plastic frame 20 and the backlight space in the vertical direction Z, while ensuring that the horizontal section of the recess portion 100 does not interfere with the first bottom surface 210 of the plastic frame 20.

The present invention provides a fixation notch 211 on the first bottom surface 210 of the plastic frame 20 and a fixation projection 111 on the first top surface 110 of the backplate 10 and the fixation projection 111 is embedded in the fixation notch 211. On one aspect, the backplate 10 can support the plastic frame 20 and the backlight space in the vertical direction Z, and on another aspect, the backplate 10 can stuck the plastic frame 20 in the horizontal direction X to avoid the thin side wall of the plastic frame 20 and then causing excessive deformation.

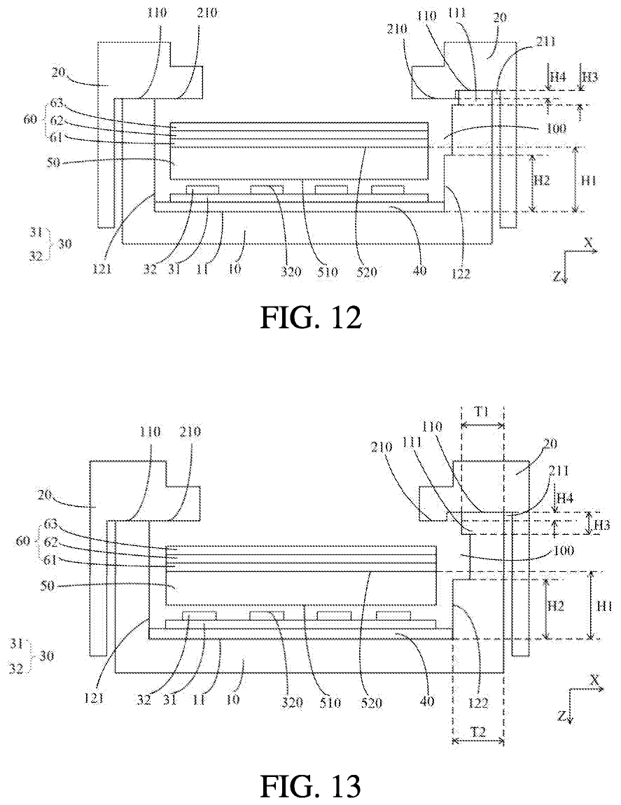

As shown in FIG. 12, which is a schematic view showing a ninth structure of a backlight module provided by one embodiment of the present invention. The backlight module comprises a backplate 10, a plastic frame 20, a light source 30, a reflective film 40, a light guiding element 50, and an optical film 60.

In this embodiment, the backlight module is a direct type backlight module. The difference between this embodiment and the structure in FIG. 11 is that the fixation projection 111 is formed on a top surface of the side plate having the recess portion 100 in this embodiment. That is, the fixation projection 111 in FIG. 12 is additionally formed on the first top surface 110 of the backplate 10 rather than directly formed by the top portion of the side plate having the recess portion 100.

There are many ways to form the fixation projection 111.

In one embodiment, the recess portion 100 is formed by cutting a part of the first top surface 110 of the backplate 10 along a vertical direction Z first, and then cutting the first top surface 110 off once again or several times. At last, the remaining portion of the top portion forms the fixation projection 111 and is embedded in the fixation notch 211. The specific process is same as that in FIG. 7.

In one embodiment, a portion of the first top surface 110 of the backplate 10 is cut down in the vertical direction Z to form a recess portion 100, and then a material is added to the first top surface 110 to form the fixation projection 111. The added material can be same as or different from the material of the backplate 10. Then, the fixation projection 111 is embedded in the fixation notch 211.

In this embodiment, the fixation projection 111 has smaller size, and thus the fixation notch 211 formed on the first bottom surface 210 of the plastic frame 20 can be smaller.

The shapes of the fixation projection 111 and the fixation notch 211 can be same or different. The height H3 of the fixation projection 111 is greater than or equal to the depth H4 of the fixation notch 211, and this ensures that the fixation projection 111 can fully extended into the fixation notch 211, support the plastic frame 20 and the backlight space in the vertical direction Z, while ensuring that the horizontal section of the recess portion 100 does not interfere with the first bottom surface 210 of the plastic frame 20.

The present invention provides a fixation notch 211 on the first bottom surface 210 of the plastic frame 20 and a fixation projection 111 on the first top surface 110 of the backplate 10 and the fixation projection 111 is embedded in the fixation notch 211. On one aspect, the backplate 10 can support the plastic frame 20 and the backlight space in the vertical direction Z, and on another aspect, the backplate 10 can stuck the plastic frame 20 in the horizontal direction X to avoid the thin side wall of the plastic frame 20 and then causing excessive deformation.

As shown in FIG. 13, which is a schematic view showing a tenth structure of a backlight module provided by one embodiment of the present invention. The backlight module comprises a backplate 10, a plastic frame 20, a light source 30, a reflective film 40, a light guiding element 50, and an optical film 60.

In this embodiment, the backlight module is a direct type backlight module. The difference between this embodiment and the structure in FIG. 11 is that the recess portion 100 has a cross-section shaped as a slot. The slot can be rectangular, trapezoidal or semicircular. The projection 111 is directly formed by the recess portion 100. That is, the uncut portion above the slot forms the projection 111 embedded in the first slot 211 after the slot is formed.

When the recess portion 100 is a slot, the first top surface 110 of the backplate 10 has a larger area than the right-angled cut of the cross-sectional surface of the recess portion 100. Thus, the support for the plastic frame 20 and the backlight space is stronger, and the slot does not block the optical film 60 when the optical film is thermally extended toward a horizontal direction, and the optical film 60 can extend toward the recess portion 100, so that wrinkles are not generated, thereby avoiding poor optics.

In this embodiment, the fixation projection 111 is directly formed by the top portion of the side plate having the recess portion 100. It is noted that because the fixation projection 111 needs to be embedded in the fixation notch 211 and the recess portion 100 has a cross-section shaped as a slot, a thickness T1 of the side plate on the upper portion of the slot have to be less than a thickness T2 of the side plate on the lower portion of the slot when forming the slot as shown in FIG. 13. Meanwhile, the recess portion 100 is formed inside the receiving chamber and passes outside of the side plate of the backplate 10, and the first top surface 110 of the second side plate is separated from the first top surface 110 of the other side plate. That is, the top portion of the fixation projection 111 is independent from the other portion of the backplate 10. The fixation projection 111 can be embedded in the fixation notch 211.

The present invention provides a fixation notch 211 on the first bottom surface 210 of the plastic frame 20 and a fixation projection 111 on the first top surface 110 of the backplate 10 and the fixation projection 111 is embedded in the fixation notch 211. On one aspect, the backplate 10 can support the plastic frame 20 and the backlight space in the vertical direction Z, and on another aspect, the backplate 10 can stuck the plastic frame 20 in the horizontal direction X to avoid the thin side wall of the plastic frame 20 and then causing excessive deformation.

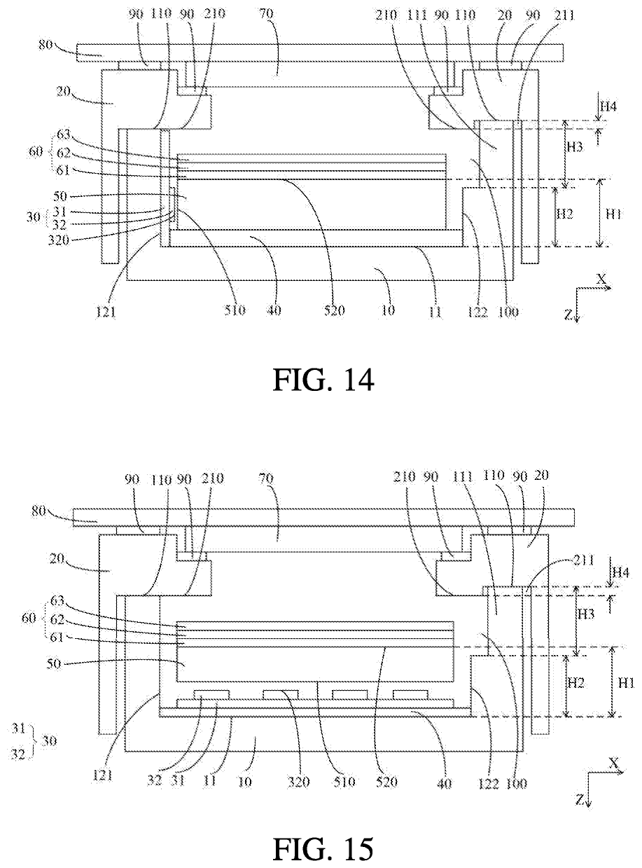

The present invention further provides a liquid crystal module. As shown in FIG. 14, which is a schematic view showing a first structure of a liquid crystal module provided by one embodiment of the present invention. The liquid crystal module comprises a liquid crystal display panel 70 and a backlight module. The backlight module comprises a backplate 10, a plastic frame 20, a light source 30, a reflective film 40, a light guiding element 50, and an optical film 60.

The liquid crystal display panel 70 and the touch panel 80 are fixed on the plastic frame 20 of the backlight module by an adhesive layer 90. The adhesive layer 90 is generally a double-sided tape or foam. The adhesive material (not shown) is also disposed between the liquid crystal display panel 70 and the touch panel 80. The adhesive material is generally an optical adhesive.

The liquid crystal module will be specifically described below with reference to FIGS. 1 to 14.

The backplate 10 generally uses cast aluminum to ensure the strength and better heat dissipation. The backplate 10 comprises a bottom plate and side plates. The bottom plate and the side plates form a receiving chamber.

The plastic frame 20 generally uses polycarbonate or polycarbonate mixed with glass fibers. The plastic frame 20 is disposed on the backplate 10. The backplate 10 comprises a first top surface 110. The plastic frame 20 comprises a first bottom surface 210. The first bottom surface 210 of the plastic frame 20 is formed on the first top surface 110 of the backplate 10.

The light source 30 is disposed inside the receiving chamber. In this embodiment, the backlight module is an edge-type backlight module. The light source 30 is disposed between the light guiding element 50 and at least one of the side plates. The light source 30 is generally disposed between the light guiding element 50 and one side surface, but it is also possible that the light source 30 is disposed between the light guiding element 50 and several side surfaces. As shown in FIG. 14, the light source 30 comprises a light bar 31 and LED lamps 32 fixed on the light bar 31, and the light bar 31 is fixed on the first side surface 121.

The light guiding element 50 is disposed inside the receiving chamber, and the light guiding element 50 has a light-input surface 510 corresponding to a light-emitting surface 320 of the light source 30. Since the backlight module is an edge type backlight module, the light guiding element 50 can be a light guiding plate, the light guiding plate transfers the horizontal incident light from the light source 30 into a vertical light and then passing through a light-emitting surface 520 of the light guiding element 50. The light guiding plate is generally formed by an optical resin material, and a thermoplastic resin, polycarbonate, and acrylic are commonly used materials.

A reflective film 40 is provided under the light guiding element 50. The reflective film 40 is disposed on the bottom plate of the backplate 10. The reflective film 40 is generally composed of a polyethylene terephthalate (PET) film coated with a high reflective metallic film thereon, or a PET composite formed by two layers of PET films with one core layer (polymer resins having high reflectance) between the two layers of PET films. The reflective film 40 is mainly used for reflecting the light leakage from the light guiding element 50 so as to increase the use of the light source.

The optical film 60 is disposed inside the receiving chamber, and located on the light-emitting surface 520 of the light guiding element 50. The optical film 60 generally includes a diffuser 61, a prism sheet 62, and a reflective polarization and brightness enhancement film 63 in stacking arrangement. The diffuser 61 is commonly formed by polyethylene terephthalate (PET) or polycarbonate (PC) with a smooth front and a rough back. The diffuser 61 is used for multiple refraction, reflection and scattering the light passing out from the light-emitting surface 520 of the light guiding element 50 so that the backlight can be more even. The prism sheet 62 is a light-gathering device that uses total reflection and refraction law to gather the scattered light and let the light exit within a certain angle, thereby increasing the brightness within an area. The reflective polarization and brightness enhancement film 63 can also increase the brightness of the backlight.

In the current vehicle backlight module, a cast aluminum part is generally used as a bottom plate, which is limited by the size of the module frame, and the gap between the optical film and the sidewall of the cast aluminum part is small. Due to the expansion of the optical film under high temperature conditions, when the sufficient space between the edge of the film and the sidewall of the cast aluminum part cannot be reserved, the film may be wrinkled due to the expansion, thereby causing optical defects.

In the present invention, at least one of the side plates of the backplate 10 is provided with the recess portion 100 at a position corresponding to the optical film 60, and the recess portion 100 faces toward the optical film 60. When the optical film 60 is thermally expanded toward the horizontal direction X, the recess portion 100 does not block the optical film 60, and the optical film 60 can extend toward the recess portion, so that wrinkles are not generated, thereby avoiding poor optics.

In one embodiment, the light source 30 is disposed between the light guiding element 50 and at least one of the side plates. At least one of the side plates without the light source 30 is provided with the recess portion 100.

The light source 30 can be disposed between the light guiding element 50 and two or three side plates. The recess portion 100 on the side plates without the light source 30 is formed by the same method in the above embodiment. The recess portion 100 can be formed on all of the side plates, it is also possible to form the recess portion 100 on a part of the side plates.

In this embodiment, the recess portion 100 has a cross-sectional surface shaped as a right-angled cut. That is, when the recess portion 100 is formed, it is also cut by a horizontal direction and a vertical direction Z. In order to ensure that the optical film 60 is unblocked when it expands, the cutting depth along the horizontal direction X is sufficient to ensure the thickness of the cast aluminum part (minimum thickness 0.8 mm) and sufficient expansion gap at high temperature is reserved for the optical film 60. In one embodiment, the recess portion 100 has a depth ranging from ¼ to ¾ of the thickness of the side plate.

When cutting along the vertical direction Z, the recess portion 100 has a height H2 from the bottom surface 11 less than or equal to a height H1 from the bottom surface 11 of the optical film 60. In this embodiment, the difference between H1 and H2 is 0.1 to 0.2 mm. That is, when the optical film 60 expends and enters the recess portion 100, a direction of 0.1 to 0.2 mm is maintained in the vertical direction Z between the bottom portion of the optical film 60 and the backplate 10, and this ensures that the optical film 60 can smoothly expand into the recess portion 100 without colliding with the backplate 10.

In one embodiment, as shown in FIG. 2, the width S2 of the recess portion 100 is greater than or equal to the width S1 of the optical film 60, and this ensures that the optical film 60 can smoothly expand into the recess portion 100 without colliding with the backplate 10.

In one embodiment, as shown in FIG. 3, a width S2 of the recess portion 100 is less than a width S1 of the optical film 60. The optical film 60 has a notch 601 within an area larger than the width of the recess portion 100 at a side of the optical film 60 close to the recess portion 100. When the optical film 60 expands into the recess portion 100, since the notch 601 is formed, this ensures that the optical film 60 can smoothly expand into the recess portion 100 without colliding with the backplate 10.

It should be noted that the shape of the recess portion 100 is not limited thereto. The shape of the recess portion 100 can be other shapes. As long as the bottom surface and the side surface of the optical film 60 are both not in contact with the backplate 10 when it expands, the person skilled in the art can design the shape of the recess portion 100 as needed.

In one embodiment, the recess portion 100 has a cross-sectional surface shaped as a slot. The cross-sectional surface of the slot can be a rectangle, a trapezoid, or a semicircle. When the recess portion 100 is a slot, the first top surface 110 of the backplate 10 has a larger area than the right-angled cut of the cross-sectional surface of the recess portion 100. Thus, the support for the plastic frame 20 and the backlight space is stronger, and the slot does not block the optical film 60 when the optical film is thermally extended toward a horizontal direction X, and the optical film 60 can extend toward the recess portion 100, so that wrinkles are not generated, thereby avoiding poor optics.

The first bottom surface 210 of the plastic frame 20 is provided with a fixation notch 211, and the side plate having the recess portion 100 is provided with a fixation projection 111. The plastic frame 20 is fixed on the side plate by the fixation notch 211 and the fixation projection 111.

The cross-sectional surface of the fixation notch 211 can be at least one of a rectangle, a trapezoid, and a semicircle. In this embodiment, the fixation projection 111 is directly formed by a top portion of the side plate having the recess portion 100. That is, when the recess portion 100 is formed, a portion of the first top surface 110 of the backplate 10 is cut down along the vertical direction Z, and the first top surface 110 has an area reduced relative to the original one. The remaining portion of the first top surface 110 of the backplate 10 forms the fixation projection 111 engaged in the fixation notch 211.

It should be noted that the ways to form the fixation projection 111 is not limited thereto. In one embodiment, the recess portion 100 has a cross-sectional surface shaped as a right-angled cut. The fixation projection 111 is formed on a top surface of the side plate having the recess portion 100. That is, the fixation projection 111 is additionally formed on the first top surface 110 of the backplate 10 rather than directly formed by the top portion of the side plate having the recess portion 100.

In one embodiment, the recess portion 100 is formed by cutting a part of the first top surface 110 of the backplate 10 along a vertical direction Z first, and then cutting the first top surface 110 off once again or several times. At last, the remaining portion of the top portion forms the fixation projection 111 and is embedded in the fixation notch 211.

In one embodiment, a portion of the first top surface 110 of the backplate 10 is cut down in the vertical direction Z to form a recess portion 100, and then a material is added to the first top surface 110 to form the fixation projection 111. The added material can be same as or different from the material of the backplate 10. Then, the fixation projection 111 is embedded in the fixation notch 211.

The fixation projection 111 formed by this way has smaller size, and thus the fixation notch 211 formed on the first bottom surface 210 of the plastic frame 20 can be smaller.

The shape of the fixation projection 111 depends on the shape of the recess portion 100. In one embodiment, the shape of the fixation projection 111 is the same as that of the fixation notch 211. The cross-sectional surface of them are both at least one of a rectangle, a trapezoid, and a semicircle, or other shapes.

In one embodiment, the shape of the fixation projection 111 is different from that of the fixation notch 211. For example, the shape of the fixation notch 211 is a rectangle, but the shape of the fixation projection 111 is a semicircle. The shapes of the fixation projection 111 and the fixation notch 211 can be designed by requirement.

The height H3 of the fixation projection 111 is greater than or equal to the depth H4 of the fixation notch 211, and this ensures that the fixation projection 111 can fully extended into the fixation notch 211, support the plastic frame 20 and the backlight space in the vertical direction Z, while ensuring that the horizontal section of the recess portion 100 does not interfere with the first bottom surface 210 of the plastic frame 20.

The present invention provides a recess portion 100 on the side surface corresponding to the optical film 60, and when the optical film 60 is thermally expanded toward the horizontal direction X, the recess portion 100 does not block the optical film 60, and the optical film 60 can extend toward the recess portion, so that wrinkles are not generated, thereby avoiding poor optics.

Moreover, the present invention provides a fixation notch 211 on the first bottom surface 210 of the plastic frame 20 and a fixation projection 111 on the first top surface 110 of the backplate 10 and the fixation projection 111 is embedded in the fixation notch 211. On one aspect, the backplate 10 can support the plastic frame 20 and the backlight space in the vertical direction Z, and on another aspect, the backplate 10 can stuck the plastic frame 20 in the horizontal direction X to avoid the thin side wall of the plastic frame 20 and then causing excessive deformation.

As shown in FIG. 15, which is a schematic view showing a second structure of a liquid crystal module provided by one embodiment of the present invention. The liquid crystal module comprises a liquid crystal display panel 70 and a backlight module. The backlight module comprises a backplate 10, a plastic frame 20, a light source 30, a reflective film 40, a light guiding element 50, and an optical film 60.

The liquid crystal display panel 70 and the touch panel 80 are fixed on the plastic frame 20 of the backlight module by an adhesive layer 90. The adhesive layer 90 is generally a double-sided tape or foam. The adhesive material (not shown) is also disposed between the liquid crystal display panel 70 and the touch panel 80. The adhesive material is generally an optical adhesive.

The difference between this embodiment and the structure in FIG. 14 is that the backlight module is a direct type backlight module in this embodiment. The light source 30 is disposed between the light guiding element 50 and the bottom plate of the backplate 10. The reflective film 40 is disposed between the light source 30 and the backplate 10. The light source 30 emits light bottom up. The light-input surface 510 of the light guiding element 50 corresponds to the light-emitting surface 320 of the light source 30. In this embodiment, the light guiding element 50 is a diffuser. The diffuser fully scatters the incident light from the light source 30 and has a good shadowing effect on the light shadow, making the light source softer and more uniform.

Since the side surface of the backplate 10 comprises a first side surface 121, a second side surface 122, a third side surface 123 and a fourth side surface 124, and the light source 30 is disposed on the bottom surface 11, at least one of the first side surface 121, the second side surface 122, the third side surface 123, and the fourth side surface 124 has the recess portion 100 formed thereon.

In this embodiment, the recess portion 100, the fixation projection 111, and the fixation notch 211 have the arrangement same as that in the embodiment of FIG. 14, and the details are not described herein again. The present invention provides a recess portion 100 on the side surface corresponding to the optical film 60, and when the optical film 60 is thermally expanded toward the horizontal direction X, the recess portion 100 does not block the optical film 60, and the optical film 60 can extend toward the recess portion, so that wrinkles are not generated, thereby avoiding poor optics. Moreover, the present invention provides a fixation notch 211 on the first bottom surface 210 of the plastic frame 20 and a fixation projection 111 on the first top surface 110 of the backplate 10 and the fixation projection 111 is embedded in the fixation notch 211. On one aspect, the backplate 10 can support the plastic frame 20 and the backlight space in the vertical direction Z, and on another aspect, the backplate 10 can stuck the plastic frame 20 in the horizontal direction X to avoid the thin side wall of the plastic frame 20 and then causing excessive deformation.

According to above embodiments, it can be understood that:

The present invention provides a backlight module and a liquid crystal module. The backlight module comprises a backplate, a light source, a light guiding element, an optical film, and a plastic frame. The backplate comprises a bottom plate and side plates. The bottom plate and the side plates form a receiving chamber. The light source is disposed inside the receiving chamber. The light guiding element is disposed inside the receiving chamber. A light-emitting surface of the light source corresponds to a light-input surface of the light guiding element. The optical film is disposed inside the receiving chamber, and located at a light-emitting surface of the light guiding element. The plastic frame is disposed on the backplate. It is characterized that at least one of the side plates is provided with a recess portion at a position corresponding to the optical film, and the recess portion faces toward the optical film. By setting a recess portion on the side surface of the backplate corresponding to the position of the optical film, when the optical film is thermally expanded, the recess portion does not block the optical film, and the optical film can extend toward the recess portion, so that wrinkles are not generated, thereby avoiding poor optics.

The present invention has been described with preferred embodiments thereof but the preferred embodiments are not intended to limit the present invention. It is understood that many changes and modifications to the described embodiments can be carried out by the skilled person in the art without departing from the scope and the spirit of the invention that is intended to be limited only by the appended claims.

What is claimed is:

1. A backlight module, comprising:
a backplate comprising a bottom plate and side plates, wherein the bottom plate and the side plates form a receiving chamber;
a light source disposed inside the receiving chamber;
a light guiding element disposed inside the receiving chamber, wherein the light source has a light-emitting surface corresponding to a light-input surface of the light guiding element;
an optical film disposed inside the receiving chamber and located on a light-output surface of the light guiding element; and
a plastic frame disposed on the backplate;
wherein at least one of the side plates is provided with a recess portion at a position corresponding to the optical film, and the recess portion faces toward the optical film.

2. The backlight module according to claim 1, wherein a depth of the recess portion ranges from ¼ to ¾ of a thickness of the side plate.

3. The backlight module according to claim 1, wherein a width of the recess portion is greater than or equal to a width of the optical film.

4. The backlight module according to claim 1, wherein a width of the recess portion is less than a width of the optical film, and the optical film has a notch within an area larger than the width of the recess portion at a side of the optical film close to the recess portion.

5. The backlight module according to claim 1, wherein the light source is disposed between the light guiding plate and at least one of the side plates; or the light source is disposed between the light guiding plate and the bottom plate.

6. The backlight module according to claim 1, wherein the recess portion has a cross-sectional surface shaped as a right-angled cut or a slot.

7. The backlight module according to claim 1, wherein the plastic frame has a bottom surface provided with a fixation notch, and the side plate having the recess portion further has a fixation projection, wherein the plastic frame is fixed on the side plate by the fixation notch and the fixation projection.

8. The backlight module according to claim 7, wherein the fixation notch has a cross-sectional surface shaped as at least one of a rectangle, a trapezoid, and a semicircle.

9. The backlight module according to claim 7, wherein the fixation projection is formed by a top portion of the side plate having the recess portion, or the fixation projection is formed on a top surface of the side plate having the recess portion.

10. The backlight module according to claim 7, wherein the fixation projection has a height greater than or equal to a depth of the fixation notch.

11. The backlight module according to claim 1, wherein the backlight module further comprises a reflective film disposed on the bottom plate.

12. A liquid crystal module, comprising:
a backlight module comprising a backplate, a light source, a light guiding plate, an optical film, and a plastic frame, wherein the backplate comprises a bottom plate and side plates, wherein the bottom plate and the side plates form a receiving chamber; the light source, the light guiding plate, and the optical film are disposed inside the receiving chamber, wherein the light source has a light-emitting surface corresponding to a light-input surface of the light guiding element, and the optical film is located on a light-output surface of the light guiding element; the plastic frame is disposed on the backplate; and
a liquid crystal display panel fixed on the plastic frame;
wherein at least one of the side plates is provided with a recess portion at a position corresponding to the optical film, and the recess portion faces toward the optical film.

13. The liquid crystal module according to claim 12, wherein the plastic frame has a bottom surface provided with a fixation notch, and the side plate having the recess portion further has a fixation projection, wherein the plastic frame is fixed on the side plate by the fixation notch and the fixation projection.

14. The liquid crystal module according to claim 13, wherein the fixation projection has a height greater than or equal to a depth of the fixation notch.

15. The liquid crystal module according to claim 12, wherein a depth of the recess portion ranges from ¼ to ¾ of a thickness of the side plate.

16. The liquid crystal module according to claim 12, wherein the liquid crystal module further comprises a touch panel fixed on the plastic frame.

17. The liquid crystal module according to claim 12, wherein the backlight module further comprises a reflective film disposed on the bottom plate.

18. The liquid crystal module according to claim 12, wherein the light source is disposed between the light guiding plate and at least one of the side plates; or the light source is disposed between the light guiding plate and the bottom plate.

19. The liquid crystal module according to claim 14, wherein the recess portion has a cross-sectional surface shaped as a right-angled cut or a slot.

20. The liquid crystal module according to claim 1, wherein a width of the recess portion is greater than or equal to a width of the optical film.
